(19) United States
(12) Patent Application Publication
(10) Pub. No.: US 2016/0337530 A1
(43) Pub. Date: Nov. 17, 2016

(54) INFORMATION PROCESSING APPARATUS THAT CONTROLS DISPLAY AT TIME OF OCCURRENCE OF ABNORMALITY, METHOD OF CONTROLLING THE SAME, AND STORAGE MEDIUM

(71) Applicant: CANON KABUSHIKI KAISHA, Tokyo (JP)

(72) Inventors: Yasuhiro Kozuka, Tokyo (JP); Keishi Inaba, Toride-shi (JP)

(21) Appl. No.: 15/149,226

(22) Filed: May 9, 2016

(30) Foreign Application Priority Data
May 15, 2015 (JP) 2015-099898

(51) Int. Cl. H04N 1/00

(52) U.S. Cl. CPC H04N 1/00076; H04N 1/00408; H04N 1/00477; H04N 1/00005; H04N 1/00021; H04N 1/00037; H04N 1/0049

(57) ABSTRACT

An information processing apparatus in which in a case where an abnormality related to a controller for controlling display has occurred, a display image is changed to an image associated with the abnormality. First and second image output units output images, respectively. A switching unit selectively switches a source of image output to the display unit, between the first and second image output units. When an abnormality of the first image output unit is detected, the switching unit is controlled such that the image output from the second image output unit is output to the display unit.

### BACKGROUND OF THE INVENTION

1. Field of the Invention

The present invention relates to a technique for controlling display on a display unit of an information processing apparatus.

2. Description of the Related Art

Conventionally, in general, an information processing apparatus includes a display unit for notifying a user of an operation image and a status of the apparatus. Display on the display unit is controlled by a display control CPU. When an abnormality has occurred in the display control CPU, it is impossible to perform correct display on the display unit. For example, the screen of the display unit becomes completely dark. If no image is displayed, the user cannot determine in what abnormal state the information processing apparatus is in.

To cope with this, there has been proposed a technique for detecting a failure of a motherboard using a failure detection unit, and changing a display image according to whether or not a failure of the motherboard has been detected (Japanese Patent Laid-Open Publication No. 2011-8418). In this technique, if no failure of the motherboard has been detected, an image output from the motherboard is displayed on a display, whereas if a failure of the motherboard has been detected, an image stored in advance is displayed on the display.

In Japanese Patent Laid-Open Publication No. 2011-8418, however, if a failure of the motherboard has been detected, image information stored in advance in an image signal-storing unit is simply output, and hence the user cannot determine details of the failure from the displayed image. More specifically, the user cannot know whether an abnormality has been caused by a failure of the motherboard itself, or whether the motherboard cannot be operated due to a failure of power supply. This causes a problem that it is sometimes impossible to finely identify a faulty component, a faulty part, a cause of the failure, or the like.

### SUMMARY OF THE INVENTION

The present invention provides an information processing apparatus in which in a case where an abnormality related to a controller for controlling display has occurred, a display image is changed to an image associated with the abnormality, a method of controlling the same, and a storage medium.

In a first aspect of the present invention, there is provided an information processing apparatus comprising a display unit, a first image output unit configured to output image data corresponding to an image to be displayed on the display unit, a second image output unit configured to output image data corresponding to an image to be displayed on the display unit, a switching unit configured to selectively switch an output source of image data to the display unit, between the first image output unit and the second image output unit, a detection unit configured to detect an abnormality of the first image output unit, and a control unit configured to control, according to detection of the abnormality of the first image output unit by the detection unit, the switching unit such that the image data output from the second image output unit is output to the display unit.

In a second aspect of the present invention, there is provided a method of controlling an information processing apparatus including a display unit, a first image output unit configured to output image data corresponding to an image to be displayed on the display unit, a second image output unit configured to output image data corresponding to an image to be displayed on the display unit, and a switching unit configured to selectively switch an output source of image data to the display unit, between the first image output unit and the second image output unit, the method comprising detecting an abnormality of the first image output unit, and controlling, according to detection of the abnormality of the first image output unit by said detecting, the switching unit such that the image data output from the second image output unit is output to the display unit.

In a third aspect of the present invention, there is provided a non-transitory computer-readable storage medium storing a computer-executable program for executing a method of controlling an information processing apparatus including a display unit, a first image output unit configured to output image data corresponding to an image to be displayed on the display unit, a second image output unit configured to output image data corresponding to an image to be displayed on the display unit, and a switching unit configured to selectively switch an output source of image data to the display unit, between the first image output unit and the second image output unit, wherein the method comprises detecting an abnormality of the first image output unit, and controlling, according to detection of the abnormality of the first image output unit by said detecting, the switching unit such that the image data output from the second image output unit is output to the display unit.

According to the present invention, in a case where an abnormality related to the controller for controlling display has occurred, a display image is changed to an image associated with the abnormality.

Further features of the present invention will become apparent from the following description of exemplary embodiments (with reference to the attached drawings).

### BRIEF DESCRIPTION OF THE DRAWINGS

FIG. 1 is a block diagram of an information processing apparatus according to a first embodiment of the invention.

FIG. 2 is a schematic block diagram of the internal configuration of a controller unit and a console unit appearing in FIG. 1.

FIG. 3 is a block diagram of a self-diagnosis section of the controller unit.

FIG. 4 is a block diagram of first and second failure detection units of the self-diagnosis section.

FIG. 5 is a timing diagram showing waveforms of signals related to the first and second failure detection units in a case of a normal state.

FIG. 6 is a timing diagram showing the waveforms of the signals related to the first failure detection unit in a case where an abnormality is detected by the first failure detection unit.

FIG. 7 is a schematic block diagram of the internal configuration of an IO controller.

FIG. 8A is a flowchart of an image generation process.

FIG. 8B is a flowchart of a diagnostic result notification process.

FIG. 8C is a flowchart of a display control process.

FIG. 9A is a diagram showing an example of display on an LCD in a case where the first failure detection unit detects an abnormality.

FIG. 9B is a diagram showing an example of display on the LCD in a case where the second failure detection unit detects an abnormality.

FIG. 10 is a schematic block diagram of the internal configuration of a controller unit and a console unit of an information processing apparatus according to a second embodiment of the present invention.

FIG. 11 is a block diagram of the internal configuration of an IO controller of the controller unit.

FIG. 12 is a flowchart of a display control process performed by a sub CPU of the controller unit.

FIG. 13 is a schematic block diagram of the internal configuration of a controller unit and a console unit of an information processing apparatus according to a third embodiment of the present invention.

### DESCRIPTION OF THE EMBODIMENTS

The present invention will now be described in detail below with reference to the accompanying drawings showing embodiments thereof.

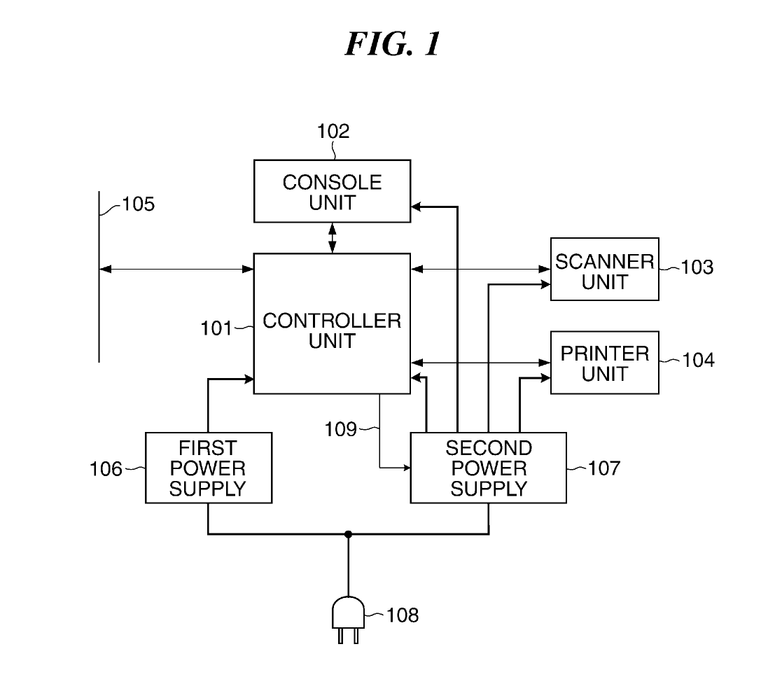

FIG. 1 is a block diagram of an information processing apparatus according to a first embodiment of the invention. The information processing apparatus is configured as an image printing apparatus, for example.

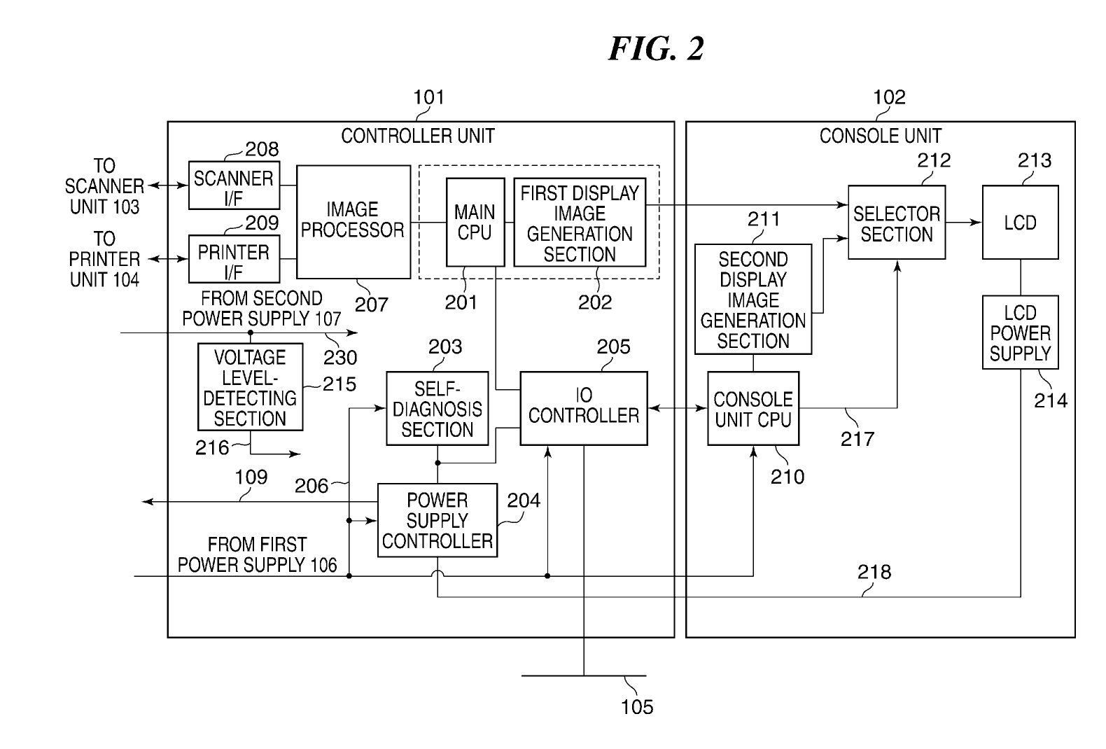

The image printing apparatus as the information processing apparatus according to the first embodiment is comprised of a controller unit 101 for controlling components of the image printing apparatus, a scanner unit 103, a printer unit 104, a console unit 102, and so forth. The controller unit 101 is a component which controls the operation of the image printing apparatus, and performs data transmission and reception, data conversion, data storage, power control, and so forth. The console unit 102 includes an operation panel for allowing a user to perform various operations, and an LCD (Liquid Crystal Display) 213 (see FIG. 2) as a display section for displaying operation information. The printer unit 104 prints out various kinds of input images processed by the controller unit 101. The scanner unit 103 scans an image, and supplies the scanned image to the controller unit 101. A LAN 105 is an example of a network via which the controller unit 101 is connected to external apparatuses.

A first power supply 106 and a second power supply 107 are both power supplies for converting an AC voltage of commercial power supplied from a power plug 108 to a DC voltage used by each component of the image printing apparatus. The power output of the second power supply 107 is controlled by a power supply control signal 109 delivered from the controller unit 101. In a normal mode, both the first power supply 106 and the second power supply 107 are on. In a power saving mode, only the second power supply 107 is off. Here, the power saving mode refers to a state where supply of electric power to components other than the controller unit 101 is stopped in order to reduce power consumption of the commercial power supply when the image printing apparatus is not performing job processing. In the power saving mode, it is possible to detect receipt of a job by the controller unit 101 using power supplied from the first power supply 106. Upon receipt of the job, the controller unit 101 turns on the second power supply 107 by switching the power supply control signal 109 in order to shift the image printing apparatus to the normal mode.

FIG. 2 is a schematic block diagram of the internal configuration of the controller unit 101 and the console unit 102.

In the controller unit 101, a main CPU 201 is a first controller for controlling components of the controller unit 101, and forms a main controller. A first display image generation section 202 (first image output section) is controlled by the main CPU 201, and generates and outputs an image for being displayed on the LCD 213 of the console unit 102. A self-diagnosis section 203 (detection unit) has a function for performing a diagnosis concerning whether or not the controller unit 101 and the components connected to the controller unit 101 are normally operating. The self-diagnosis section 203 also has a function for performing a diagnosis concerning which component inside the controller unit 101 is faulty. A power supply controller 204 performs not only normal power supply control, but also control of power supply to the controller unit 101 and the components connected to the controller unit 101, according to an abnormality, in a case where occurrence of the abnormality is determined as a result of self-diagnosis by the self-diagnosis section 203.

An IO controller 205 not only controls communication with external apparatuses via the LAN 105 and inter-CPU communication between the main CPU 201 and a console unit CPU 210, referred to hereinafter, of the console unit 102 but also controls the components of the controller unit 101 and the console unit 102 according to information on a result of the self-diagnosis from the self-diagnosis section 203. First power 206 from the first power supply 106 is supplied not only to the self-diagnosis section 203, the power supply controller 204, and the IO controller 205, but also to the console unit CPU 210 of the console unit 102. Second power 230 from the second power supply 107 is supplied to the other components of the controller unit 101 and the console unit 102.

In the example illustrated in FIG. 2, the first power 206 from the first power supply 106 and the second power 230 from the second power supply 107 are directly supplied to the components of the controller unit 101 and the console unit 102. However, the first power 206 and the second power 230 may be converted to power supply voltages required by components using a DC-DC converter or a regulator.

An image processor 207 performs various image processing on input image data, and outputs the processed image data. A scanner interface 208 captures image data scanned and acquired by the scanner unit 103, into the controller unit 101, and outputs the image data to the image processor 207. A printer interface 209 sends out image data processed by the image processor 207 to the printer unit 104.

A voltage level-detecting section 215 detects the voltage level of the second power 230 supplied from the second power supply 107, and upon detecting that the second power 230 has been supplied at a normal voltage level, generates a power-good signal 216. When the second power 230 is supplied to the main CPU 201 to assert the power-good signal 216, the main CPU 201 starts to be started up.

In the console unit 102, the console unit CPU 210 controls the components of the console unit 102, and communicates with the IO controller 205 of the controller unit 101. A second display image generation section 211 (second image output section) is controlled by the console unit CPU 210, and generates and outputs an image for being displayed on the LCD 213 of the console unit 102. A selector section 212 is a switching section controlled by the console unit CPU 210. Both an image generated by the first display image generation section 202 and an image generated by the second display image generation section 211 are input to the selector section 212. The selector section 212 selectively switches the source of an image output to the LCD 213 between the first display image generation section 202 and the second display image generation section 211 according to a control signal 217 from the console unit CPU 210. An image from the selected source is output to the LCD 213. The selector section 212 is configured to select the first display image generation section 202 as the source, in a normal state (state where no abnormality occurs), so as to cause the image generated by the first display image generation section 202 to be output to the LCD 213. An LCD power supply 214 supplies a backlight power to the LCD 213 according to a control signal 218 from the power supply controller 204.

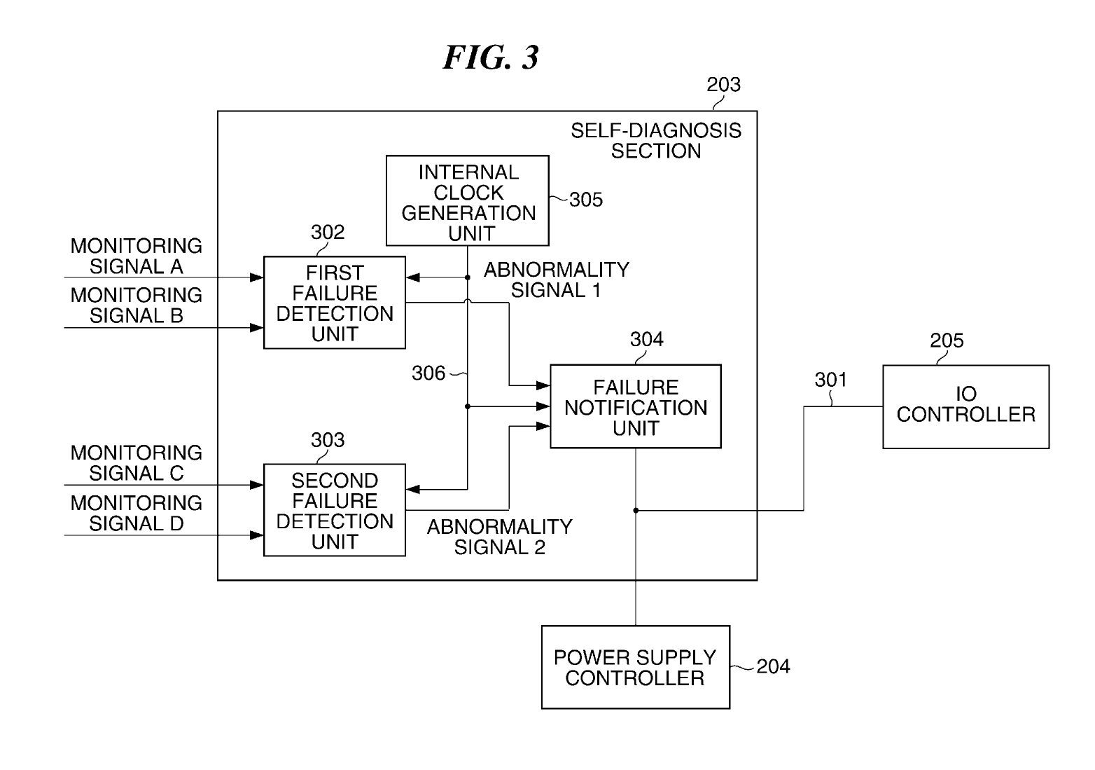

FIG. 3 is a block diagram of the self-diagnosis section 203 of the controller. A system bus 301 which the IO controller 205 accesses is connected to the self-diagnosis section 203. The self-diagnosis section 203 monitors monitoring signals A, B, C, and D, described hereinafter, which are used in the controller unit 101, and detects an abnormality related to the main CPU 201 based on results of monitoring of the monitoring signals. A first failure detection unit 302 monitors the monitoring signals A and B, and a second failure detection unit 303 monitors the monitoring signals C and D.

An abnormality detected by the first failure detection unit 302 is input to a failure notification unit 304 as an abnormality signal 1 at a high level, and an abnormality detected by the second failure detection unit 303 is input to the failure notification unit 304 as an abnormality signal 2 at a high level. When the abnormality signal 1 or 2 at the high level is input, the failure notification unit 304 generates an interrupt signal according to the abnormality signal 1 or 2, and delivers the interrupt signal to the IO controller 205. Upon receipt of the interrupt signal from the failure notification unit 304, the IO controller 205 accesses a failure notification register (not shown) of the failure notification unit 304, and checks a failure type.

An internal clock generation unit 305 generates an internal clock signal 306 for driving the first failure detection unit 302, the second failure detection unit 303, and the failure notification unit 304. The internal clock signal 306 is different from a system clock (not shown) used in the controller unit 101. By using such an internal clock signal, it is possible to obtain an advantageous effect that operations for failure detection and display can be performed even when the system clock is not operating. Although in the present embodiment, the self-diagnosis section 203 includes the two failure detection units (302 and 303), by way of example, this is not limitative but the self-diagnosis section 203 may be configured to include three or more failure detection units.

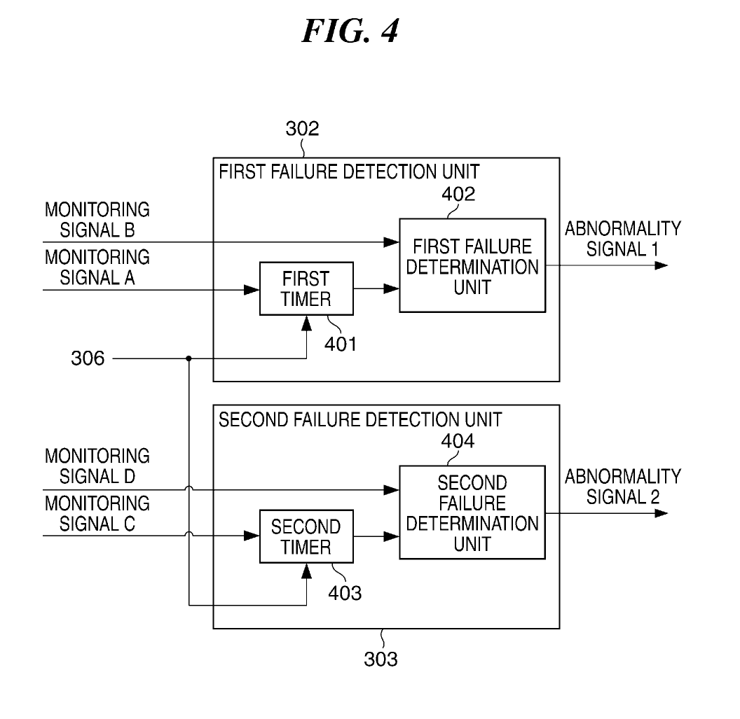

FIG. 4 is a block diagram of the first failure detection unit 302 and the second failure detection unit 303.

The monitoring signals A and B are input to the first failure detection unit 302. More specifically, the monitoring signal A is the power-good signal 216 (FIG. 2). The monitoring signal B is a signal input from a register (not shown) of the self-diagnosis section 203. The IO controller 205 and the main CPU 201 communicate with each other when the image printing apparatus is started up, and if a response is received from the main CPU 201, the IO controller 205 generates the monitoring signal B by writing data corresponding to a high level in the above-mentioned register via the system bus 301.

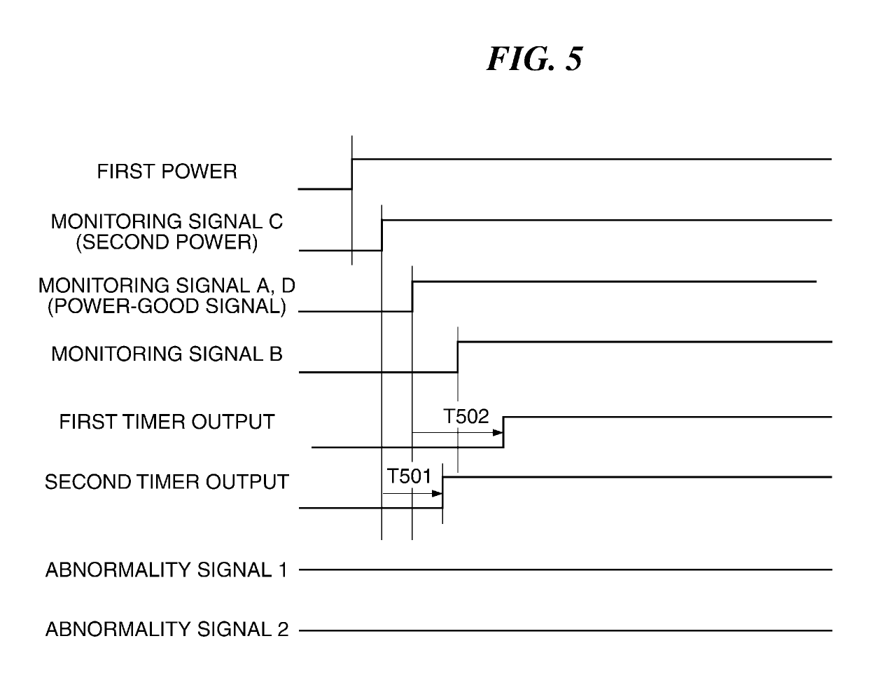

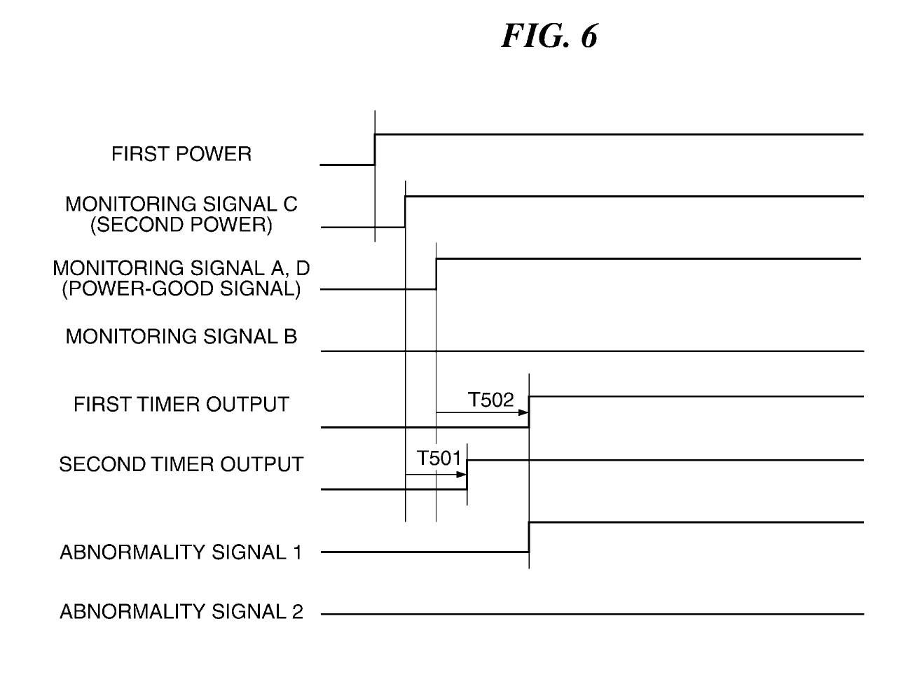

When the monitoring signal A is changed to the high level, the first failure detection unit 302 causes a first timer 401 to start counting time. The first timer 401 is operated by the internal clock signal 306. When a predetermined time period T502 (see FIGS. 5 and 6) has elapsed, the first timer 401 changes an output signal from a low level to a high level, and delivers the signal to a first failure determination unit 402. The first failure determination unit 402 has the monitoring signal B as well input thereto. The monitoring signal B is a signal which is to be changed from a low level to a high level before the first timer 401 counts up the predetermined time period T502 (FIGS. 5 and 6) when in the normal state. Therefore, when the first timer 401 has counted up the predetermined time period T502, if the monitoring signal B has not been changed from the low level to the high level, it is determined that an abnormality related to the main CPU 201 has occurred. In this case, the first failure determination unit 402 changes the abnormality signal 1 from a low level to the high level, and transmits information indicating that an abnormality has been detected, to the failure notification unit 304.

Although the second failure detection unit 303 differs from the first failure detection unit 302 only in the monitoring signals input thereto, it has the same basic configuration as the first failure detection unit 302. The monitoring signals C and D are input to the second failure detection unit 303. The monitoring signal C indicates power supply from the second power supply 107. The monitoring signal D is the power-good signal 216.

When power supply from the second power supply 107 is started, the monitoring signal C is input, and a second timer 403 starts counting time. When the second timer 403 has counted up a predetermined time period T501 (see FIGS. 5 and 6), if the monitoring signal D has not been changed from a low level to a high level, it is determined that an abnormality related to the power supply has occurred. In this case, the second failure determination unit 404 changes the abnormality signal 2 from a low level to the high level, and transmits information indicating that an abnormality related to the power supply has been detected, to the failure notification unit 304.

As described hereinabove, in the present embodiment, the first failure detection unit 302 determines whether or not the power-good signal 216 for the second power supply 107 supplied to the main CPU 201 is normal (valid), and also the main CPU 201 has normally operated. The second failure detection unit 303 determines whether or not the power from the second power supply 107 is normally supplied and also a power supply sequence to the voltage level-detecting section 215 has normally operated. In short, the first failure detection unit 302 detects an operational abnormality of the main CPU 201, and the second failure detection unit 303 detects abnormalities of the power supply system, such as an abnormality of the power supply sequence and an abnormality of power supply from the power supply unit. These abnormalities are defined as an abnormality related to the main CPU 201 in the present invention.

Note that the monitoring signals A to D are not limited to the illustrated examples. However, it is desirable that the monitoring signals A and C are signals which are associated with respective sections desired to be diagnosed and are changed at the start of the power supply sequence thereof, and the monitoring signals B and D are signals each for determining that an associated one of the sections desired to be diagnosed has normally operated.

FIGS. 5 and 6 are timing diagrams showing the waveforms of the signals related to the first and second failure detection units 302 and 303. FIG. 5 is a timing diagram in the case of the normal state and FIG. 6 is a timing diagram in the case where an abnormality is detected by the first failure detection unit 302.

First, during the normal state, as shown in FIG. 5, when a power supply SW (not shown) is turned on, the first power 206 is input. Then, power is supplied from the second power supply 107, and accordingly, the monitoring signal C is input. When the monitoring signal C is input, the second timer 403 of the second failure detection unit 303 starts counting time. When the predetermined time period T501 is counted up by the second timer 403, the second failure detection unit 303 determines whether or not the monitoring signal D is at the high level. If it is detected that the monitoring signal D is at the high level, the second failure detection unit 303 determines that the power supply system is in the normal state, and holds the abnormality signal 2 as it is (at the low level).

Next, when the power-good signal 216 is normally detected to cause the monitoring signal A to be changed to the high level, the first timer 401 of the first failure detection unit 302 starts counting time. When the predetermined time period T502 is counted up by the first timer 401, the first failure detection unit 302 determines whether or not the monitoring signal B has been changed to the high level. If it is detected that the monitoring signal B has been changed to the high level, the first failure detection unit 302 determines that the main CPU 201 is in the normal state, and holds the abnormality signal 1 as it is (at the low level).

In a case where both of the output levels of the abnormality signal 1 and the abnormality signal 2 are at the low level, the failure notification unit 304 stores information indicating that the power supply system and the main CPU 201 are in the normal state, in the failure notification register (not shown). Here, the failure notification register has a number of bits, which is at least not smaller than the number of bits of the failure notification unit 304. Then, the failure notification unit 304 transmits a notification interrupt to the IO controller 205 via the system bus 301. Upon detection of the notification interrupt from the failure notification unit 304, the IO controller 205 checks the failure notification register, and determines that the main CPU 201 has been normally started up.

FIG. 6 shows an example in which the monitoring signal B is not changed to the high level before completion of counting of the predetermined time period T502 after the monitoring signal A is changed to the high level (within the predetermined time period), and hence the abnormality signal 1 is changed to the high level. Note that in this example, since the second failure detection unit 303 detects no abnormality, operations other than those of the monitoring signal B and the abnormality signal 1 are the same as in FIG. 5.

When the power-good signal 216 is normally detected to cause the monitoring signal A to be changed to the high level, the first timer 401 of the first failure detection unit 302 starts counting time. Since the monitoring signal B is not changed but remains at the low level when the predetermined time period T502 has been counted up by the first timer 401, the first failure detection unit 302 determines that an abnormality has occurred in the operation of the main CPU 201, and changes the abnormality signal 1 from the low level to the high level.

The failure notification unit 304 stores information indicating that the output level of the abnormality signal 1 is at the high level and the abnormality signal 2 is at the low level, in the failure notification register, and then transmits a notification interrupt to the IO controller 205 via the system bus 301. Upon detection of the notification interrupt from the failure notification unit 304, the IO controller 205 checks the failure notification register, and determines that a startup abnormality has occurred in the main CPU 201.

Note that although not shown in FIG. 6, in a case where the monitoring signal D is not changed to the high level before completion of counting of the predetermined time period T501 after the output level of the monitoring signal C is changed to the high level, the second failure detection unit 303 determines that an abnormality has occurred in the power supply system. Then, the second failure detection unit 303 changes the abnormality signal 2 to the high level. The failure notification unit 304 stores information indicating that the output level of the abnormality signal 2 is at the high level, in the failure notification register. The IO controller 205 checks the failure notification register, and determines that an abnormality has occurred in the power supply system.

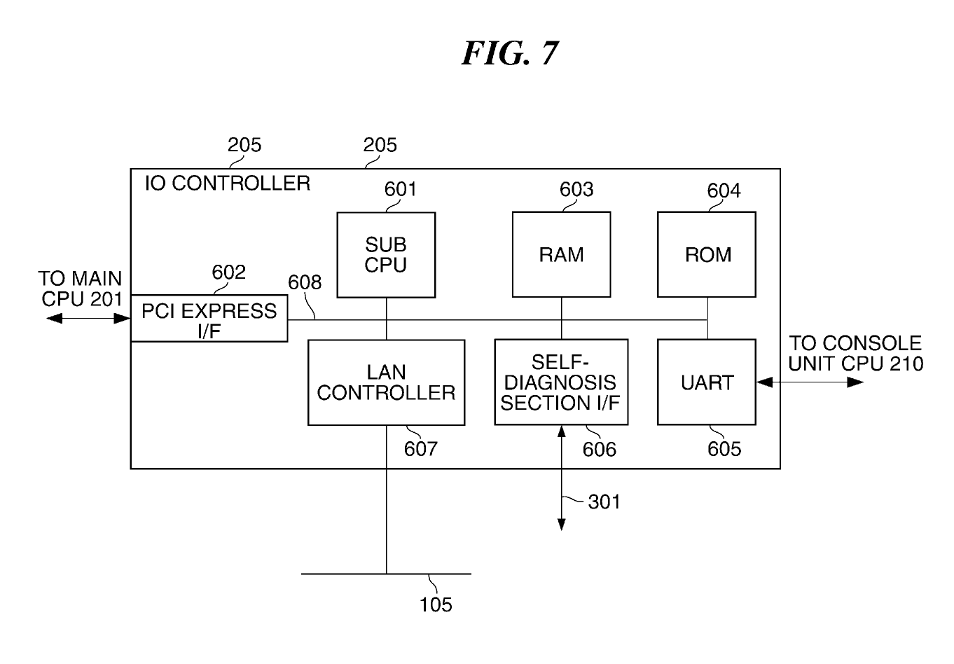

FIG. 7 is a schematic block diagram of the internal configuration of the IO controller 205. In the normal state, a sub CPU 601 controls components of the IO controller 205 to control inter-CPU communication between itself and the main CPU 201 and the console unit CPU 210, and various interfaces. A PCI Express interface 602 performs inter-CPU communication with the main CPU 201. A RAM 603 is used as a work memory for the sub CPU 601. A ROM 604 is a nonvolatile memory, and stores control programs executed by the controller unit 101. A UART (Universal Asynchronous Receiver Transmitter) 605 is an interface for performing inter-CPU communication between the sub CPU 601 and the console unit CPU 210. A self-diagnosis section interface 606 is an interface which connects the IO controller 205 to the self-diagnosis section 203 and the power supply controller 204 via the system bus 301. A LAN controller 607 is connected to the LAN 105 to control the input and output of information from and to the external apparatuses connected to the LAN 105. Note that the functional blocks of the IO controller 205 are connected to each other via an internal bus 608, and are configured such that they can be controlled not only by the sub CPU 601 but also by the main CPU 201 via the PCI Express interface 602.

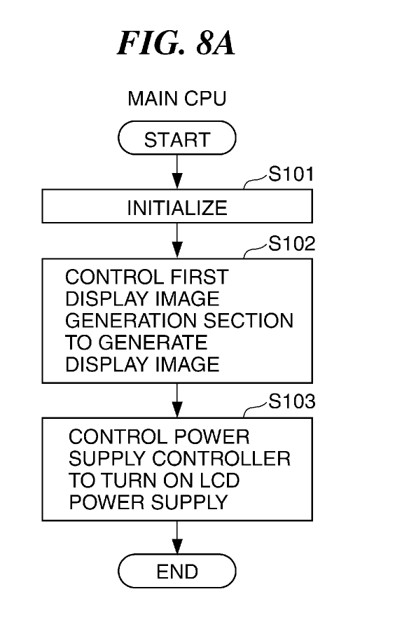

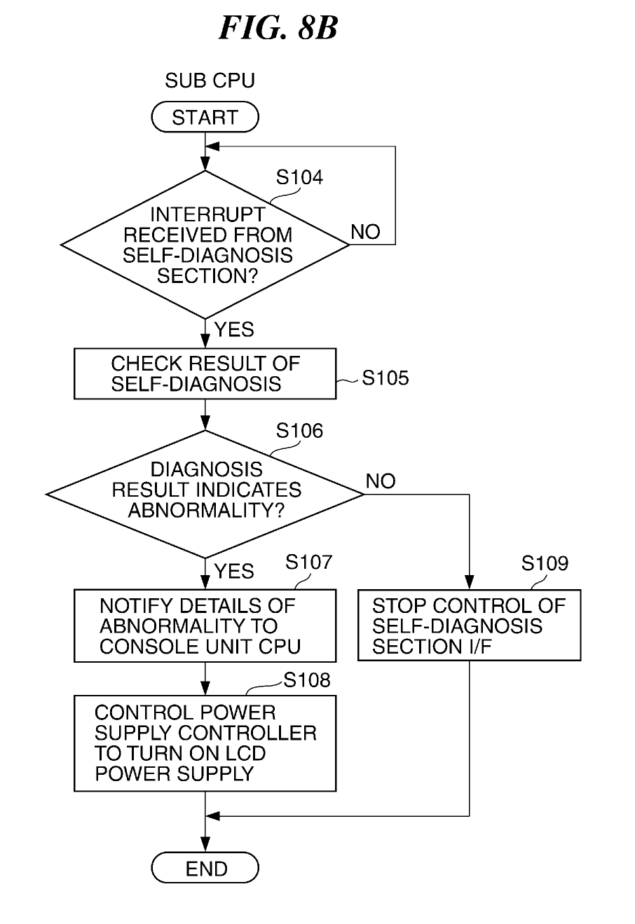

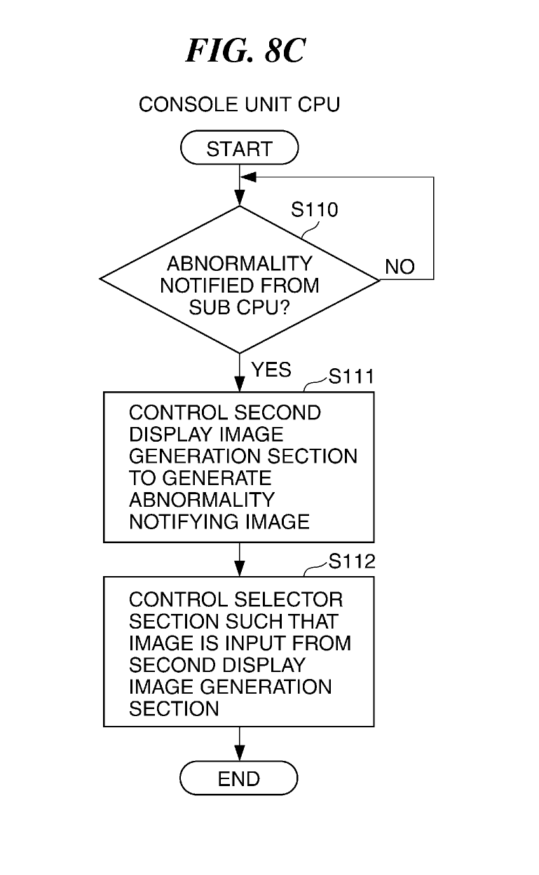

FIG. 8A is a flowchart of an image generation process performed by the main CPU 201. This image generation process is started when power is supplied from the second power supply 107 and the power-good signal 216 is normally detected.

First, the main CPU 201 performs initialization (step S101), and controls the first display image generation section 202 to generate a display image (step S102). Next, the main CPU 201 controls the self-diagnosis section interface 606 of the IO controller 205 to control the power supply controller 204 via the system bus 301 to turn on the LCD power supply 214, thereby causing power to be supplied to the LCD 213 (step S103), followed by terminating the present process.

In a case where the main CPU 201 can be normally started up, i.e. in a case where there has occurred no abnormality related to the main CPU 201, an image output from the first display image generation section 202 is displayed on the LCD 213. In this case, the ON/OFF of the LCD power supply 214 is controlled by the main CPU 201. On the other hand, in a case where the main CPU 201 cannot be normally started up, the first display image generation section 202 cannot output a display image. In this case, image display is realized under the control of the sub CPU 601 and the console unit CPU 210, as described hereafter with reference to FIGS. 8B and 8C.

FIG. 8B is a flowchart of a diagnostic result notification process performed by the sub CPU 601. This diagnostic result notification process is started when the first power 206 from the first power supply 106 is supplied to the IO controller 205.

First, the sub CPU 601 waits for a notification interrupt concerning a result of self-diagnosis from the self-diagnosis section 203 (step S104). Upon receipt of the notification interrupt, the sub CPU 601 proceeds to a step S105. In the step S105, the sub CPU 601 refers to the failure notification register of the self-diagnosis section 203, and checks the results of self-diagnosis. Next, the sub CPU 601 determines based on the result of the self-diagnosis whether or not an abnormality related to the main CPU 201 has occurred (step S106). If it is determined that no abnormality related to the main CPU 201 has occurred, the sub CPU 601 stops the control of the self-diagnosis section interface 606 from the sub CPU 601 (step S109). With this, the control of the power supply controller 204 at the start of the main CPU 201 is left to the main CPU 201, followed by terminating the present process.

On the other hand, if it is determined that an abnormality related to the main CPU 201 has occurred, the sub CPU 601 controls the UART 605 to notify the console unit CPU 210 of the abnormality and details thereof by command communication with the console unit CPU 210 (step S107). Here, a method of notifying the console unit CPU 210 is not particularly limited. For example, there may be employed a method of causing the console unit CPU 210 to notify a number for selecting one of a plurality of display images set in advance, or a method of performing serial transmission of information to be displayed as character code information.

Next, the sub CPU 601 controls the self-diagnosis section interface 606 to control the power supply controller 204 via the system bus 301 to turn on the LCD power supply 214, thereby causing power to be supplied to the LCD 213 (step S108), followed by terminating the present process. Therefore, if an abnormality related to the main CPU 201 has occurred, the ON/OFF of the LCD power supply 214 is controlled by the sub CPU 601.

FIG. 8C is a flowchart of a display control process performed by the console unit CPU 210. This display control process is started when the first power 206 from the first power supply 106 is supplied to the console unit CPU 210.

First, the console unit CPU 210 determines whether or not the notification of occurrence of an abnormality, which is transmitted from the sub CPU 601 in the step S107 in FIG. 8B, has been received (step S110). If the notification of occurrence of an abnormality has been received, the console unit CPU 210 proceeds to a step S111. In the step S111, the console unit CPU 210 controls the second display image generation section 211 to generate a display image according to the details of the notified abnormality.

Here, the method of generating the display image according to the details of the notified abnormality is not particularly limited. For example, a plurality of images may be prepared and stored in advance in a place accessible by the console unit CPU 210 such that the console unit CPU 210 can select an image associated with the detected abnormality from the prepared images. Alternatively, in a case where a configuration in which the information on the abnormality is transmitted as the character code information is employed, the console unit CPU 210 may generate an image according to the character code. In this case, for example, a text may be output which is formed by conversion from the character code using a conversion table. These contribute to reduction of communication load, shortening of processing time by avoiding a process for generating a complicated image, and so forth.

Next, the console unit CPU 210 controls the selector section 212 using the control signal 217 such that the source of the output of an image to the LCD 213 is switched to the second display image generation section 211 (step S112). As a consequence, an image output from the second display image generation section 211 is displayed on the LCD 213, followed by terminating the present process.

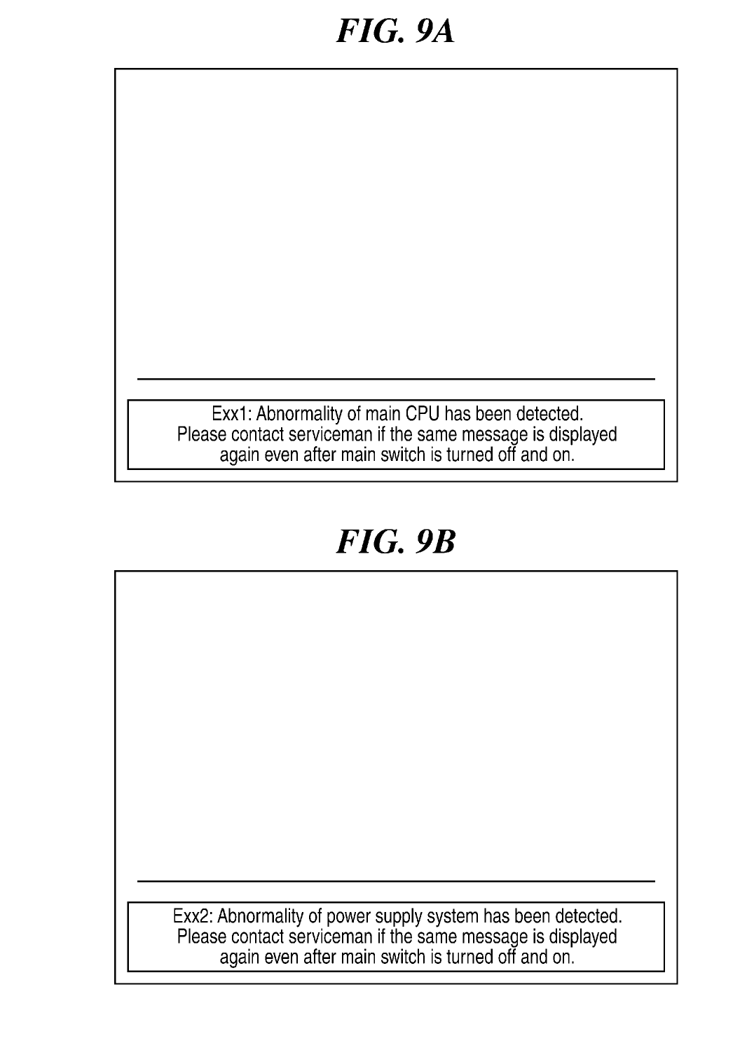

FIGS. 9A and 9B are diagrams showing examples of display on the LCD 213 in cases where the first failure detection unit 302 and the second failure detection unit 303 have detected abnormalities, respectively. Images displayed on the LCD 213 are output from the second display image generation section 211.

First, in a case where an abnormality has occurred in the operation of the main CPU 201, as shown in FIG. 9A, a message to the effect that an abnormality has occurred in the main CPU 201 is displayed, and a procedure of operations to be performed after occurrence of the abnormality or the like is advised. On the other hand, in a case where an abnormality of the power supply system has been detected, as shown in FIG. 9B, a message to the effect that an abnormality has occurred in the power supply system is displayed, and a procedure of operations to be performed after detection of the abnormality or the like is advised. In both of the examples, images displayed in main display areas above the messages may be images which make the details of the abnormalities easily visually recognizable.

According to the present embodiment, in a case where the self-diagnosis section 203 has not detected an abnormality related to the main CPU 201, an image caused to be output from the first display image generation section 202 by the main CPU 201 is displayed on the LCD 213 via the selector section 212. However, when an abnormality related to the main CPU 201 has been detected, the sub CPU 601 notifies the fact to the console unit CPU 210. The console unit CPU 210 causes the second display image generation section 211 to output an image associated with the details of the notified abnormality, and controls the selector section 212 to change the source of the output of the image to the LCD 213, thereby causing the image output from the second display image generation section 211 to be displayed on the LCD 213. Therefore, in a case where there has occurred an abnormality related to the main controller (main CPU 201) that controls the display, the sub CPU 601 and the console unit CPU 210 can control the display instead of the main CPU 201, whereby it is possible to switch the display such that an image associated with the abnormality is displayed. This makes it possible for the user not only to recognize the occurrence of the abnormality but also to easily identify the details of the abnormality or failure since the image displayed upon occurrence of the abnormality is associated with the abnormality.

Further, the main CPU 201, and the sub CPU 601 and the console unit CPU 210 are operated by respective different power supplies, and the sub CPU 601, the console unit CPU 210 and the self-diagnosis section 203 are operated by a common power supply. Therefore, even when an abnormality has occurred in the power supply for operating the main CPU 201, display processing is ensured by the sub CPU 601 and the console unit CPU 210.

Further, the backlight power supply (LCD power supply 214) of the LCD 213 as well is controlled by the main CPU 201 when no abnormality has occurred, whereas when an abnormality has occurred, the backlight power is controlled by the sub CPU 601 instead of the main CPU 201. This makes it possible to secure the backlight power even when an abnormality has occurred, and change the CPU responsible for the control of the backlight power, with flexibility and adaptability, according to whether or not the abnormality has been detected.

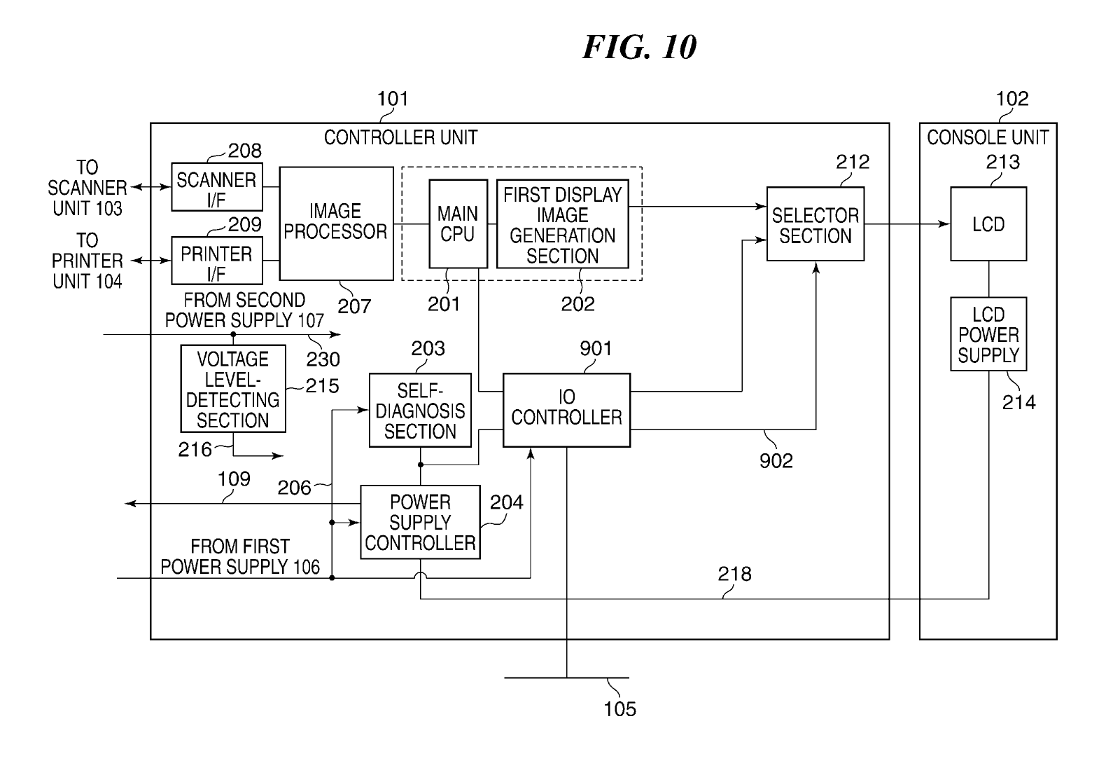

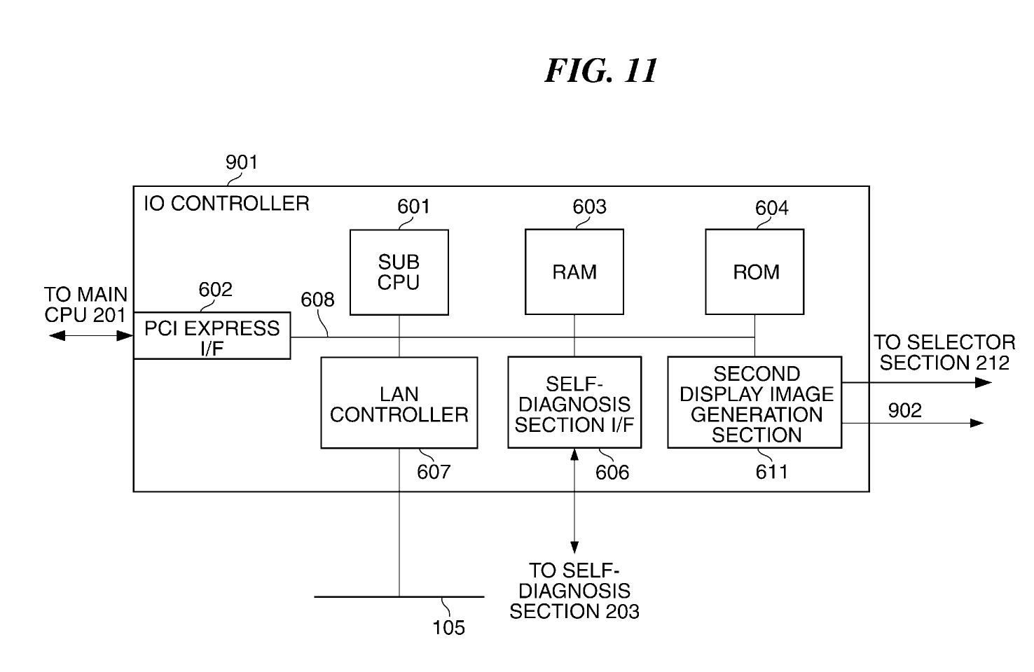

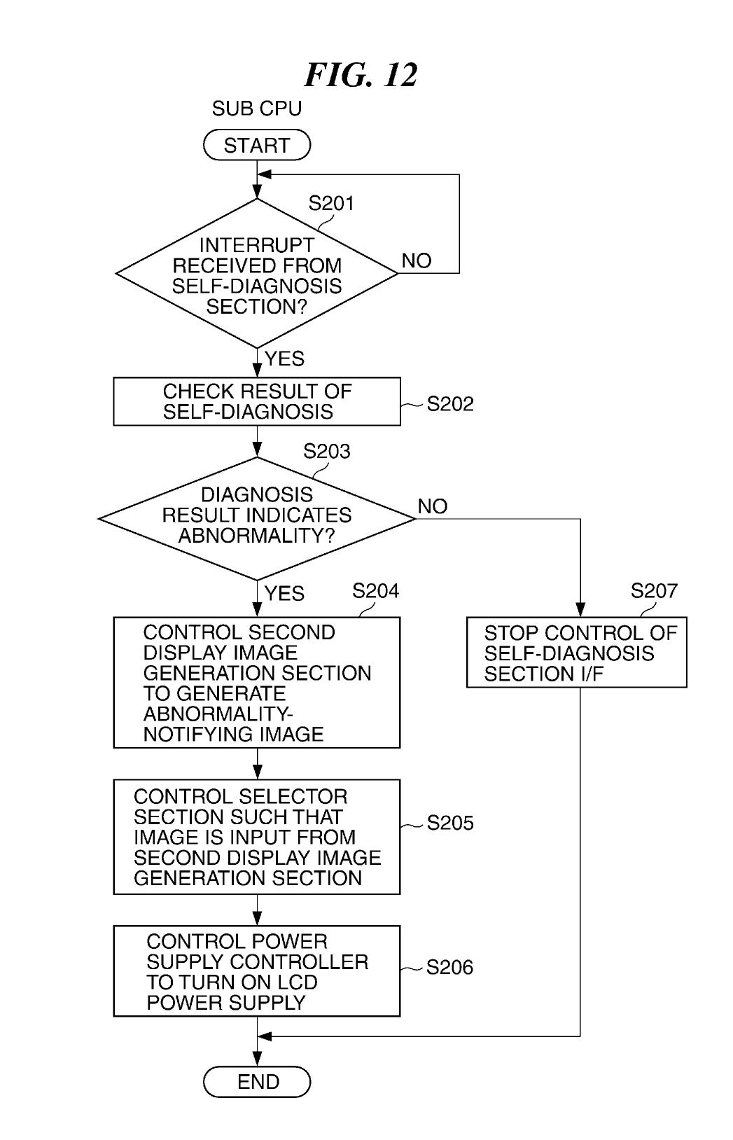

Next, a second embodiment of the present invention will be described. In the above-described first embodiment, the main CPU 201 corresponds to a first control unit for controlling the first display image generation section 202, and the sub CPU 601 and the console unit CPU 210 correspond to a second control unit for controlling the second display image generation section 211 and the selector section 212. In contrast, the second embodiment of the present invention is configured such that although the main CPU 201 corresponds to the first control unit, an IO controller 901 (FIG. 10) plays the role of the second display image generation section 211 and the console unit CPU 210. Therefore, differently from the first embodiment, the second embodiment is described with reference to FIGS. 10 and 11 instead of FIGS. 2 and 7, and to FIG. 12 instead of FIGS. 8B and 8C.

FIG. 10 is a schematic block diagram of the internal configuration of the controller unit 101 and the console unit 102 according to the second embodiment. FIG. 11 is a block diagram of the internal configuration of the IO controller 901. In FIGS. 10 and 11, components corresponding to those of the first embodiment are denoted by the same reference numerals, and description thereof is omitted.

The selector section 212 is provided not in the console unit 102 but in the controller unit 101 (FIG. 10). The console unit CPU 210 is eliminated. The controller unit 101 includes the IO controller 901. The IO controller 901 does not include the UART 605. The second display image generation section 211 is provided in the IO controller 901 (FIG. 11). The second display image generation section 211 is controlled by the sub CPU 601, and generates a display image as required. Further, under the control of the sub CPU 601, the second display image generation section 211 outputs a control signal 902 at a time at which the display image is output, and controls the selector section 212 to change the source of the output of the display image.

As described above, the IO controller 901 is configured to include the second display image generation section 211 and also control the control signal 902 transmitted to the selector section 212. Note that to simplify an interface between the controller unit 101 and the console unit 102, the selector section 212 is disposed within the controller unit 101. However, this is not limitative, but the selector section 212 may be disposed in either of the controller unit 101 and the console unit 102.

FIG. 12 is a flowchart of a display control process performed by the sub CPU 601. This display control process is started when the first power 206 from the first power supply 106 is supplied to the IO controller 901. Note that the image generation process by the main CPU 201 is the same as described with reference to FIG. 8A.

In steps S201, S202, and S203, the sub CPU 601 performs the same processing as in the steps S104, S105, and S106 in FIG. 8B. If it is determined in the step S203 that no abnormality related to the main CPU 201 has occurred, in a step S207, the sub CPU 601 performs the same processing as in the step S109 in FIG. 8B, followed by terminating the present process. With this, the control of the power supply controller 204 at the start of the main CPU 201 is left to the main CPU 201.

On the other hand, if it is determined that an abnormality related to the main CPU 201 has occurred, the sub CPU 601 controls the second display image generation section 211 to generate a display image as a bitmap image according to the details of the detected abnormality (step S204). In this case as well, the method of generating the display image according to the details of the notified abnormality is not particularly limited. Similar to the first embodiment, the configuration may be such that a plurality of images are prepared in advance and the sub CPU 601 selects an image associated with the detected abnormality from the prepared images.

Next, the sub CPU 601 controls the selector section 212 using the control signal 902 such that the source of the output of the image to the LCD 213 is switched to the second display image generation section 211 (step S205). Further, in a step S206, the sub CPU 601 performs the same processing as in the step S108 in FIG. 8B, followed by terminating the present process. The image output from the second display image generation section 211 is thus displayed on the LCD 213.

According to the present embodiment, in a case where there has occurred an abnormality related to a controller for controlling display, as far as the switching of a display image to an image associated with the abnormality is concerned, it is possible to obtain the same advantageous effects as provided by the first embodiment. Particularly, by incorporating the second display image generation section 211 in the IO controller 901, and controlling the selector section 212 to switch the source of the output of a display image via the IO controller 901, it is possible to obtain the same advantageous effects as provided by the first embodiment, with a simpler construction.

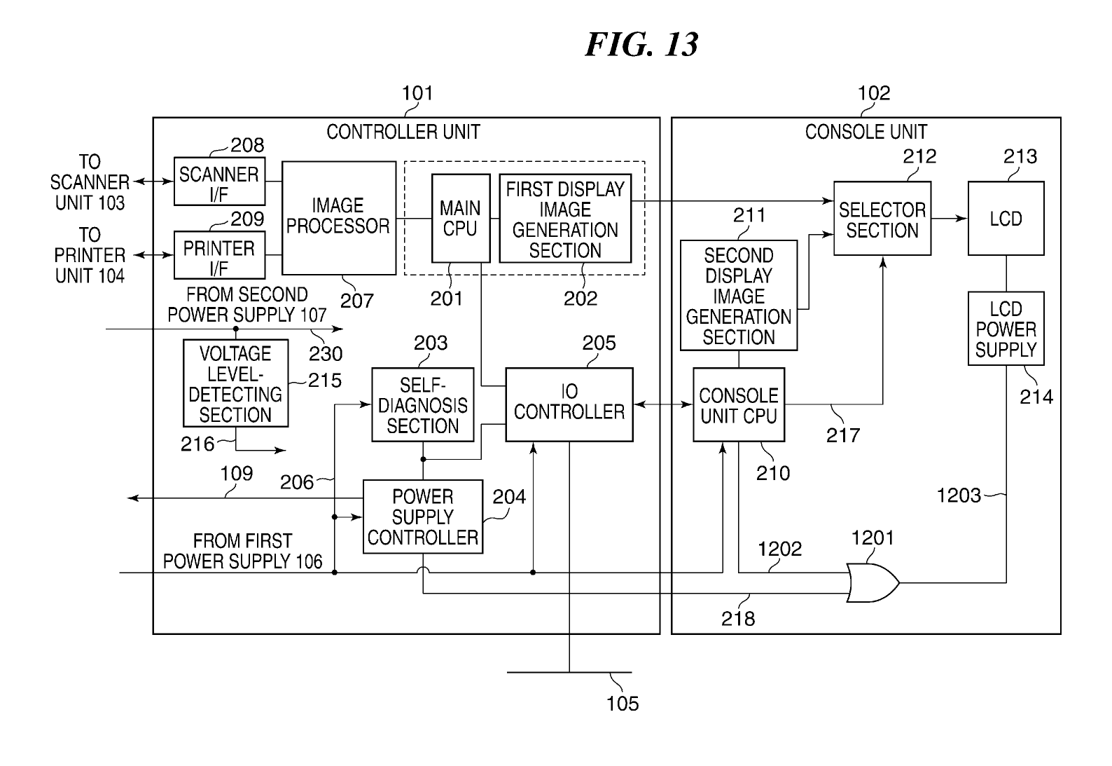

Next, a third embodiment of the present invention will be described. In the above-described first embodiment, in a case where an abnormality related to the main CPU 201 has occurred, the backlight power supply (LCD power supply 214) of the LCD 213 is controlled by the sub CPU 601 instead of the main CPU 201. In contrast, in the third embodiment of the present invention, the backlight power supply of the LCD 213 is controlled by the console unit CPU 210 instead of the main CPU 201. Therefore, differently from the first embodiment, the third embodiment is described with reference to FIG. 13 instead of FIG. 2.

FIG. 13 is a schematic block diagram of the internal configuration of the controller unit 101 and the console unit 102 according to the third embodiment. In FIG. 13, components corresponding to those of the first embodiment are denoted by the same reference numerals, and description thereof is omitted.

The console unit 102 is provided with an OR gate 1201. The control signal 218 from the power supply controller 204, and a control signal 1202 from the console unit CPU 210 are input to the OR gate 1201. An output 1203 of the OR gate 1201 is input to the LCD power supply 214 as a control signal.

In the normal state where no abnormality occurs, the console unit CPU 210 holds the control signal 1202 at the low level. This causes the LCD power supply 214 to be subjected to on-off control only according to the control signal 218 from the power supply controller 204. Therefore, the LCD power supply 214 is controlled by the main CPU 201. On the other hand, when the self-diagnosis section 203 has detected an abnormality related to the main CPU 201, the main CPU 201 cannot control the power supply controller 204 to output the control signal 218 via the self-diagnosis section interface 606 and the system bus 301 of the IO controller 205. To overcome this inconvenience, when an abnormality has occurred, the console unit CPU 210 changes the output level of the control signal 1202 to the high level, and provides the output 1203 to the LCD power supply 214 via the OR gate 1201, to thereby turn on the LCD power supply 214.

To realize such processing, for example, in the first embodiment, it is only required that the step S108 in FIG. 8B is eliminated, and a step in which the console unit CPU 210 changes the control signal 1202 to the high level is added after the step S112 in FIG. 8C.

Note that, normally, for a display section, such as the LCD 213, there is defined a timing specification between the LCD backlight power supply and an input video signal. Therefore, in a case where the output of an image from the second display image generation section 211 and the control of the LCD power supply 214 are performed by the same controller, i.e. the console unit CPU 210, as in the present embodiment, it is relatively easy to follow the above-mentioned timing specification.

According to the present embodiment, in the case where there has occurred an abnormality related to a controller for controlling display, as far as the switching of a display image to an image associated with the abnormality is concerned, it is possible to obtain the same advantageous effects as provided by the first embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-099898 filed May 15, 2015 which is hereby incorporated by reference herein in its entirety.

What is claimed is:

1. An information processing apparatus comprising:
a display unit;
a first image output unit configured to output image data corresponding to an image to be displayed on said display unit;
a second image output unit configured to output image data corresponding to an image to be displayed on said display unit;
a switching unit configured to selectively switch an output source of image data to said display unit, between said first image output unit and said second image output unit;
a detection unit configured to detect an abnormality of said first image output unit; and
a control unit configured to control, according to detection of the abnormality of said first image output unit by said detection unit, said switching unit such that the image data output from said second image output unit is output to said display unit.

2. The information processing apparatus according to claim 1, wherein in a case where no abnormality of said first image output unit has been detected by said detection unit, the image data output from said first image output unit is output to said display unit via said switching unit.

3. The information processing apparatus according to claim 2, further comprising:
a first power supply used for operating said display unit in the case where no abnormality of said first image output unit has been detected by said detection unit, and
a second power supply used for operating said display unit in the case where an abnormality of said first image output unit has been detected by said detection unit.

4. The information processing apparatus according to claim 1, wherein said control unit includes a notification unit and a processing unit,
wherein in the case where the abnormality of said first image output unit has been detected by said detection unit, said notification unit notifies details of the abnormality to said processing unit, and
wherein said processing unit causes said second image output unit to output the image data to said switching unit, which is associated with the details of the abnormality notified from said notification unit, and controls said switching unit to cause the image data output from said second image output unit to be output to said display unit.

5. The information processing apparatus according to claim 4, wherein said notification unit notifies the details of the abnormality to said processing unit as a character code, and
wherein said processing unit causes said second image output unit to generate an image according to the character code.

6. The information processing apparatus according to claim 1, wherein said control unit causes said second image output unit to select an image associated with the detected abnormality from a plurality of image prepared in advance, and output the selected image.

7. The information processing apparatus according to claim 1, wherein said control unit includes a control section configured to control said first image output unit, and cause said first image output unit to output the image data to said switching unit, and
wherein the abnormality of said first image output unit includes an abnormality related to an operation of said control section.

8. The information processing apparatus according to claim 1, wherein said control unit includes a control section configured to control said first image output unit, and cause said first image output unit to output the image data to said switching unit, and
wherein the abnormality of said first image output unit includes an abnormality related to power supply to said control section.

9. The information processing apparatus according to claim 1, wherein in a case where it cannot be determined, after a start of power supply to said control section, that a voltage level has been normalized within a predetermined time period, said detection unit detects occurrence of the abnormality of said first image output unit.

10. The information processing apparatus according to claim 1, wherein in a case where it cannot be determined, after a voltage level of power supply supplied to said control section has been normalized, that said control section has been normally operated within a predetermined time period, said detection unit detects occurrence of an abnormality of said first image output unit.

11. The information processing apparatus according to claim 8, wherein said control section and part of said control unit other than said control section are operated by respective different power supplies, and said control unit and said detection unit are operated by a common power supply.

12. A method of controlling an information processing apparatus including a display unit, a first image output unit configured to output image data corresponding to an image to be displayed on the display unit, a second image output unit configured to output image data corresponding to an image to be displayed on the display unit, and a switching unit configured to selectively switch an output source of image data to the display unit, between the first image output unit and the second image output unit,
the method comprising:
detecting an abnormality of the first image output unit; and
controlling, according to detection of the abnormality of the first image output unit by said detecting, the switching unit such that the image data output from the second image output unit is output to the display unit.

13. A non-transitory computer-readable storage medium storing a computer-executable program for executing a method of controlling an information processing apparatus including a display unit, a first image output unit configured to output image data corresponding to an image to be displayed on the display unit, a second image output unit configured to output image data corresponding to an image to be displayed on the display unit, and a switching unit configured to selectively switch an output source of image data to the display unit, between the first image output unit and the second image output unit,
wherein the method comprises:
detecting an abnormality of the first image output unit; and
controlling, according to detection of the abnormality of the first image output unit by said detecting, the switching unit such that the image data output from the second image output unit is output to the display unit.
